(19) United States
(12) Patent Application Publication
(10) Pub. No.: US 2016/0072573 A1
(43) Pub. Date: Mar. 10, 2016

(54) COMMUNICATION DEVICE, RELAY DEVICE, AND, COMMUNICATION METHOD

(71) Applicant: KABUSHIKI KAISHA TOSHIBA, Tokyo (JP)

(72) Inventors: Yuji TOHZAKA, Kawasaki (JP); Takafumi SAKAMOTO, Tokyo (JP)

(21) Appl. No.: 14/847,663

(22) Filed: Sep. 8, 2015

(30) Foreign Application Priority Data
Sep. 10, 2014 (JP) 2014-184474

(51) Int. Cl. H04B 7/14; H04L 12/733; H04W 72/04

(52) U.S. Cl. CPC H04B 7/14; H04W 72/0406; H04L 45/20; H04W 88/04

(57) ABSTRACT

According to one embodiment, a communication device wirelessly communicates with a first relay device forming a first wireless network and a second relay device forming a second wireless network. The communication device includes a first circuitry to acquire a first signal from the first relay device through wireless communication. The communication device includes a second circuitry to create, using the first signal, control information to control a terminal device existing within a coverage area of the second relay device or the second relay device and to cause the first circuitry to wirelessly transmit the control information to the terminal device or the second relay device.

### CROSS-REFERENCE TO RELATED APPLICATIONS

This application is based upon and claims the benefit of priority from Japanese Patent Application No. 2014-184474, filed Sep. 10, 2014; the entire contents of which are incorporated herein by reference.

### FIELD

Embodiments described herein relate to a communication device, a relay device, and a communication method.

### BACKGROUND

In conventional practice, a terminal device within an area where it can communicate with a first access point and a second access point, which are relay devices of a wireless LAN, can perform wireless communication with both the access points at different time points by switching connection between the first access point and the second access point. It is therefore possible, for example, to wirelessly transmit data received from the first access point through wireless communication to the second access point. In contrast, the terminal device can wirelessly transmit data received from the second access point through wireless communication to the first access point. In such a manner, the terminal device can act as a bridge of information sharing between the first access point and the second access point. In such a manner, a data transferring function has been implemented only from one access point to the other access point.

30

### BRIEF DESCRIPTION OF THE DRAWINGS

FIG. 1 is a diagram showing a communicating system 1 in a first embodiment;

FIG. 2 is a diagram showing the configuration of a slave device N1 in the first embodiment;

FIG. 3 is a sequence diagram of the process of synchronizing timing between a slave device C1 and a slave device C2 in the first embodiment;

FIG. 4 is a diagram showing a communicating system 2 in a second embodiment;

FIG. 5 is a diagram showing a slave device N2 in the second embodiment;

FIG. 6 is a diagram showing a master device H2 in the second embodiment;

FIG. 7 is a sequence diagram of the process of synchronizing a clock time between a slave device C1 and a slave device C2 in the second embodiment;

FIG. 8 is a diagram showing a communicating system 3 in a third embodiment;

FIG. 9 is a diagram showing a slave device N3 in the third embodiment;

FIG. 10 is a diagram showing a master device H3 in the third embodiment;

FIG. 11 is a sequence diagram of the control of the slave device N3 and a master device H3 in the third embodiment; FIG. 12 is a diagram showing a communicating system 4 in a fourth embodiment;

FIG. 13 is a diagram showing a slave device N4 in the fourth embodiment;

FIG. 14 is a diagram showing a master device H4 in the fourth embodiment;

FIG. 15 is a sequence diagram showing an example of a process by the communicating system 4 in the fourth embodiment;

FIG. 16 is a diagram showing a communicating system 5 in a fifth embodiment;

FIG. 17 is a diagram showing a slave device N5 in the fifth embodiment; and

FIG. 18 is a diagram showing a master device H5 in the fifth embodiment.

### DETAILED DESCRIPTION

According to one embodiment, a communication device wirelessly communicates with a first relay device forming a first wireless network and a second relay device forming a second wireless network.

The communication device includes a first circuitry to acquire a first signal from the first relay device through wireless communication.

The communication device includes a second circuitry to create, using the first signal, control information to control a terminal device existing within a coverage area of the second relay device or the second relay device and to cause the first circuitry to wirelessly transmit the control information to the terminal device or the second relay device.

Below, embodiments will be described with reference to the drawings.

### First Embodiment

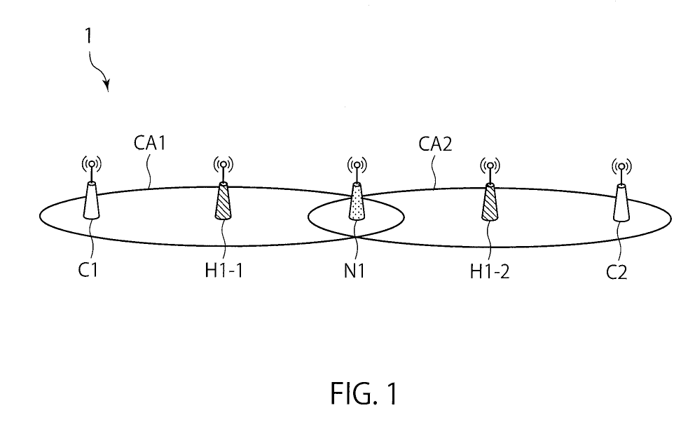

First, a first embodiment will be described. FIG. 1 is a diagram showing the configuration of a communicating system 1 in the first embodiment. As shown in FIG. 1, the communicating system 1 includes a master device (first relay device) H1-1, a master device (second relay device) H1-2, a slave device N1, and slave devices C1 and C2. In the present embodiment, the description will be made below assuming that, as an example, the master device H1-1, the master device H1-2, the slave device N1, and the slave devices C1 and C2 are positioned in a fixed manner.

The master device H1-1 and the master device H1-2 have a function as hubs in a star network and are communication devices that operate as the hubs in the star network. In the present embodiment, as an example thereof, the description will be made assuming that the master device H1-1 and the master device H1-2 are access points (APs) in a wireless LAN.

As shown in FIG. 1, the master device H1-1 forms a first wireless network and has a coverage area CA1. In contrast, the master device H1-2 forms a second wireless network that is different from the first wireless network and has a coverage area CA2. That is, the master device H1-1 and the master device H1-2 form respective individual BSSes (Basic Service Sets). The configurations of the master device H1-1 and master device H1-2 are similar to that of a conventional access point in a wireless LAN, and will not be described in detail.

The slave device N1 exists, for example, within an overlapped area of the coverage area CA1 of the master device H1-1 and the coverage area CA2 of the master device H1-2. The slave device Ni can thereby wirelessly communicate with the master device H1-1 forming the first wireless network and the master device H1-2 forming the second wireless network. The slave device N1 in the present embodiment is a communication device that is wirelessly connected to a hub in a star network, and is called a station or an STA in a wireless LAN.

The slave device Cl is positioned within the coverage area CA1, belongs to the BSS of the master device H1-1, and can wirelessly communicate with the master device H1-1.

The slave device C2 is positioned within the coverage area CA2, belongs to the BSS of the master device H1-2, and can wirelessly communicate with the master device H1-2.

The configurations of the slave devices C1 and C2 are similar to that of a conventional terminal device that can perform communication in a wireless LAN, and will not be described in detail.

In the first embodiment, the slave device N1 calculates the difference between the value of the TSF timer of the master device H1-1 and the value of the TSF timer of the master device H1-2, corrects a clock time that is wirelessly received from the slave device C1 via the master device H1-1 using the calculated difference, and transmits the corrected clock time to the slave device C2 via the master device H1-2.

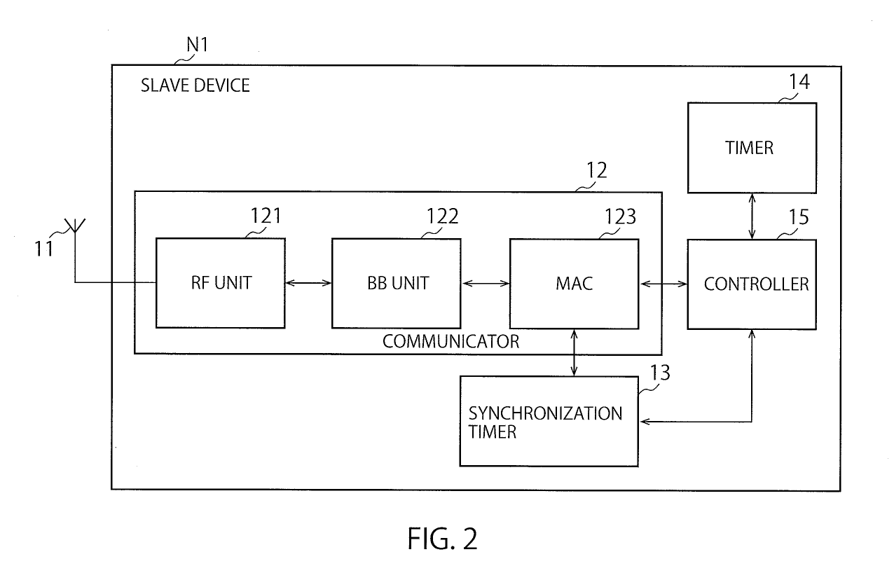

Next, the configuration of the slave device N1 in the first embodiment will be described with reference to FIG. 2. FIG. 2 is a diagram showing the configuration of the slave device N1 in the first embodiment. As shown in FIG. 2, the slave device N1 includes an antenna 11, a communicator 12, a synchronization timer 13, a timer 14, and a controller 15. These components other than the timer 14 operate in conformity with the IEEE 802.11 standard. Note that the controller 15 further has an additional function, which will be described hereafter. The communicator 12, the synchronization timer 13, the timer 14, and the controller 15 can be implemented by circuitry such as a processor or an integrated circuit. Each circuitry which implements the communicator 12, the synchronization timer 13, the timer 14, and the controller 15 may be different physical circuitry or all or a part of them may be same physical circuitry.

The communicator 12 wirelessly communicates with the master device H1-1 or the master device H1-2 via the antenna 11. For example, the communicator 12 acquires a first signal (e.g., a beacon frame) from the master device H1-1 through the wireless communication. In the present embodiment, as an example, since the slave device N1 is assumed to be positioned in a fixed manner, the first signal is acquired when the slave device N1 exists within the overlapped area of the coverage area of the master device H1-1 and the coverage area of the master device H1-2. Here, the first signal contains first radio resource information on the master device H1-1. Here, in the present embodiment, as an example, the first radio resource information is a first clock time kept by the master device H1-1.

In addition, the communicator 12 acquires a second signal (e.g., beacon frame) from the master device H1-2 through the wireless communication. In the present embodiment, as an example, since the slave device N1 is assumed to be positioned in a fixed manner, the second signal is acquired when the slave device N1 exists within the overlapped area of the coverage area of the master device H1-1 and the coverage area of the master device H1-2. Here, the second signal contains second radio resource information on the master device H1-2. Here, in the present embodiment, as an example, the second radio resource information is a second clock time kept by the master device H1-2.

In addition, for example, the communicator 12 receives time point information indicating a time point to execute a predetermined process from the slave device (second terminal device) C1 disposed within the coverage area of the master device H1-1.

Here, the communicator 12 includes an RF unit 121, a BB unit 122, and a MAC (Medium Access Controller) 123.

The RF unit 121 includes an analog signal processing circuit that is formed by a low noise amplifier (LNA), a mixer (MIX), a VCO (oscillator), and a power amplifier (PA), and the like.

The BB unit 122 performs both a transmitting process and a receiving process on control packets and data packets as baseband digital signal processing. The transmitting process is processing such as CRC addition, encryption, white noising, and forward error correction (FEC). The receiving process is processing such as correlation detection, error correction, inverse white noising, cryptanalysis, and error detection.

The MAC 123 performs access timing control on a frequency channel, connection processing, and time synchronization. The access timing control is, specifically, for example, CSMA/CA (Carrier Sense Multiple Access with Collision Avoidance). The connection processing means message exchange with the master device H1-1 or H1-2 under an appropriate authentic method and encryption system of the IEEE 802.11 standard. The time synchronization, as a slave device side function specified in the TSF (Timing Synchronization Function), is processing of overwriting the value of a TSF timer in the synchronization timer 13 with a time stamp of a beacon frame received from the master device H1-1 or H1-2. Therefore, when the slave device Ni is connected to the master device H1-1 or H 1-2, the slave device N1 synchronizes the value of the TSF timer with the master device H1-1 or H1-2.

The synchronization timer 13 counts up the value of the TSF timer.

The timer 14 counts up a timer under the control of the controller 15.

The controller 15 has a function specified in the IEEE 802.11 standard, the function relating to setting and control of a wireless link. Furthermore, the controller 15 reads the value of the TSF timer in the synchronization timer 13, as will be described hereafter, and controls the timer 14.

For example, the controller 15 creates control information to control the master device H1-2 or a terminal device disposed within the coverage area of the master device H1-2 using the acquired first signal and second signal, and causes the communicator 12 to wirelessly transmit this control information to the terminal device or the master device H 1-2.

The controller 15 includes a processor such as a CPU (Central Processing Unit), a memory such as RAM (Random Access Memory), storage, and the like, which are not shown, and implements the above-described process by the CPU reading out a program stored in the storage onto the RAM and executing the program.

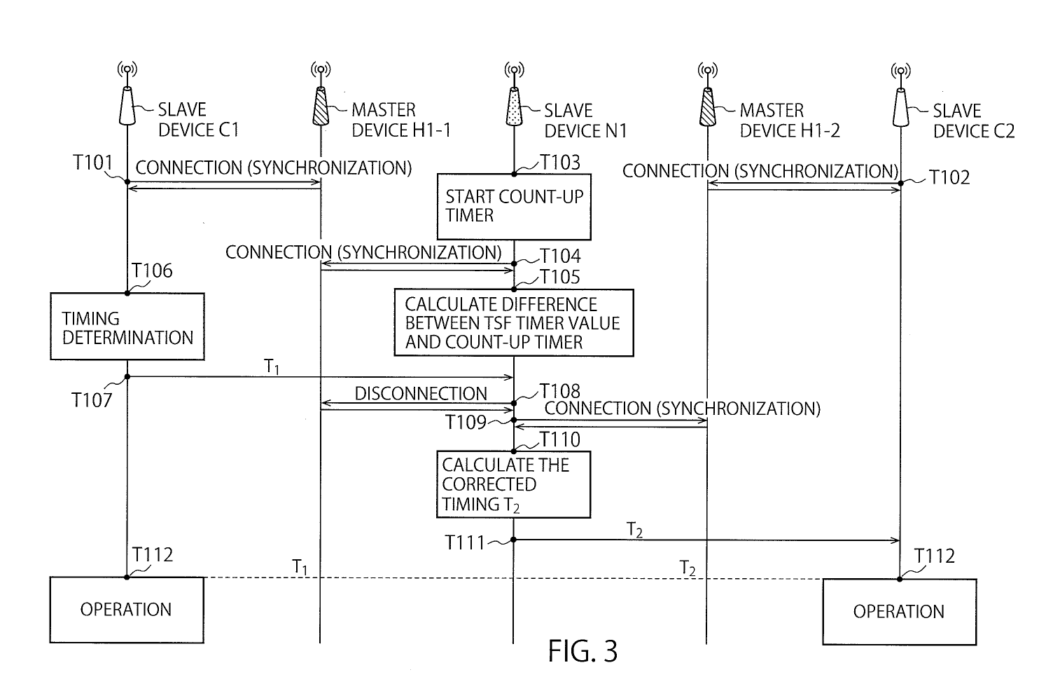

Next, there will be described with reference to FIG. 3 a method of synchronizing timing between the slave device C1 and the slave device C2 that belong to different BSSes in the first embodiment. FIG. 3 is a sequence diagram of the process of synchronizing timing between the slave device Cl and the slave device C2 in the first embodiment. With reference to FIG. 3, there will be described a method by which the slave device C1 and the slave device C2, which belong different BSSes and have the values of the TSF timers not in synchronization with each other, synchronize the starting time point of an operation with each other.
(T101) First, the slave device Cl establishes a connection to the master device H1-1. Then, the values of the TSF timers are synchronized between the slave device Cl and the master device H1-1 by the TSF.
(T102) Next, the slave device C2 establishes a connection to the master device H1-2. Then, the values of the TSF timers are synchronized between the slave device C2 and the master device H1-2 by the TSF.
(T103) Next, the controller 15 of the slave device N1 causes the timer 14 to start as a count-up timer. This causes the timer 14 to count up.
(T104) Next, the controller 15 of the slave device N1 controls the communicator 12 to establish a connection to the master device H1-1. When the connection to the master device H1-1 is established, the MAC 123 of the slave device N1 synchronizes the value of the TSF timer of the slave device N1 with that of the master device H1-1 as described above.
(T105) Next, the controller 15 of the slave device N1 calculates a difference δ₁=t₁−t between a value of the TSF timer t₁ and a value t of the operating count-up timer.
(T106) Next, the slave device C1 determines, for example, a timing T₁ at which an operation is started, based on the TSF timer. Here, T₁ is a clock time of the TSF timer to come.
(T107) Next, the slave device C1 wirelessly transmits information indicating the determined timing T₁ to the slave device N1 via the master device H1-1. The slave device N1 thereby acquires the information indicating the timing T₁ determined by the slave device C1 through wireless communication.
(T108) Next, the controller 15 of the slave device N1 disconnects the connection to the master device H1-1.
(T109) Next, the controller 15 of the slave device N1 controls the communicator 12 to establish a connection to the master device H1-2. When the connection to the master device H1-2 is established, the MAC 123 of the slave device N1 synchronizes the value of the TSF timer of the slave device Ni with that of the master device H1-2 as described above.
(T110) Next, the controller 15 of the slave device N1 calculates a difference δ₂=t₂−t between a value of the TSF timer t₂ and a value t of the operating count-up timer. Then, the controller 15 of the slave device N1 calculates a difference Δₗ₂=δ₁−δ₂=(t₁−t)−(t₂−t)=t₁−t₂ between the values of the TSF timers of the master device H1-1 and the master device H1-2, and calculates a corrected timing T₂=T₁−Δₗ₂ for the BSS formed by the master device H1-2.
(T111) Next, the slave device N1 wirelessly transmits the calculated corrected timing T₂ to the slave device C2. The slave device C2 thereby acquires information on the corrected timing T₂.
(T112) The slave device C1 performs a first process with the timing T₁ determined by the slave device C1, and the slave device C2 performs a second process with the corrected timing T₂.

In such a manner, the controller 15 corrects, for example, the time point T₁ indicated by the time point information received by the communicator 12 using the clock time difference Δ₁₂ between the first clock time t₁ and the second clock time t₂, creates the corrected timing as the control information, and causes the communicator 12 to transmits this corrected timing T₂ to the slave device C2, disposed within the coverage area of the master device H1-2, which performs a prescribed process with this corrected timing T₂. The timing T₁ determined by the slave device C1 and the corrected timing T₂ of the slave device C2 are thereby synchronized, which allows the slave device C1 and the slave device C2 to simultaneously performs a process.

Note that FIG. 3 shows the example in which timing is synchronized between the slave device C1 and the slave device C2 but the present embodiment is not limited to this. Timing may be synchronized between the master device H1-1 and the master device H1-2.

In addition, in FIG. 3, the slave device N1 switches between the connections with the two master devices H1-1 and H1-2 in a time division manner, but is not limited to this, and connections may be simultaneously established with a plurality of master devices using different frequencies. However, in this case, the slave device N1 in FIG. 2 needs to include the RF unit 121 that supports a plurality of frequencies or needs to include RF units by frequency.

As described above, in the first embodiment, the communicator 12 acquires the first signal from the master device H1-1 forming the first wireless network through wireless communication, and acquires the second signal from the master device H1-2 forming the second wireless network that is different from the first wireless network through wireless communication. The controller 15 acquires the value of the TSF timer t₁ using the first signal. In addition, the controller 15 acquires the value of the TSF timer t₂ using the second signal.

Then, the controller 15 creates the corrected timing T₂ as control information using the value of the TSF timer t₁ and the value of the TSF timer t₂, and causes the communicator 12 to wirelessly transmit this corrected timing T₂.

The timing T₁ of the slave device C1 and the corrected timing T₂ of the slave device C2 can be thereby synchronized. Therefore, a prescribed operation is performed by the slave device C1 with the timing T₁ and by the slave device C2 with the corrected timing T₂, which makes the slave device C1 and the slave device C2 simultaneously perform a process.

Note that, in the first embodiment, the communicating system 1 includes two master devices, the master device H1-1 and the master device H1-2, and one slave device, the slave device N1, which can wirelessly communicate with the master device H1-1 and the master device H1-2, but is not limited to this. The communicating system 1 may include three or more master devices, and may include a plurality of slave devices N1 that can communicate with the plurality of master devices.

### Second Embodiment

Next, a second embodiment will be described. In the first embodiment, timing to start an operation is synchronized between the slave device C1 and the slave device C2 by correcting the timing T1 determined by the slave device C1. In contrast thereto, in the second embodiment, master devices synchronize clock times kept by them with each other to synchronize clock times kept by the slave device C1 and the slave device C2.

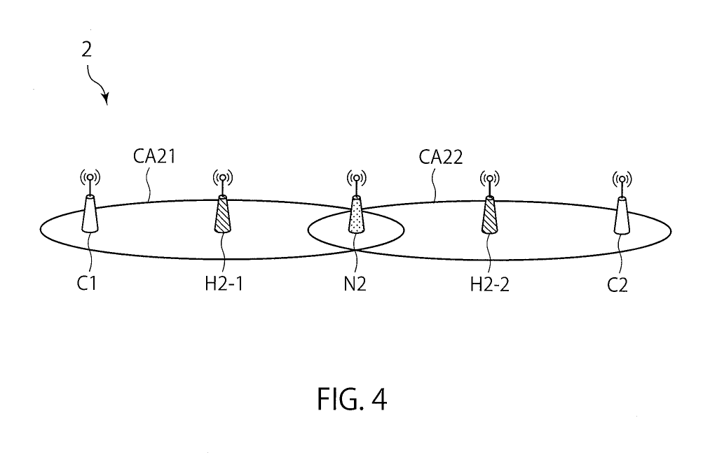

Next, the configuration of a communicating system 2 in the second embodiment will be described with reference to FIG. 4. FIG. 4 is a diagram showing the configuration of the communicating system 2 in the second embodiment. Note that components identical to those in FIG. 1 are denoted by the same reference characters, and will not be described specifically. The configuration of the communicating system 2 in the second embodiment is a configuration, with respect to the configuration of the communicating system 1 in the first embodiment, in which the slave device N1 is changed to a slave device (terminal device) N2, the master device H1-1 is changed to a master device (first relay device) H2-1, and the master device H1-2 is changed to a master device (second relay device) H2-2. In the present embodiment, as an example, the description will be made below assuming that the master device H2-1, the master device H2-2, the slave device N2, and the slave devices C1 and C2 are positioned in a fixed manner.

The master device H2-1 and the master device H2-2 have a function as hubs in a star network and are communication devices that operate as the hubs in the star network. In the present embodiment, as an example thereof, the description will be made assuming that the master device H2-1 and the master device H2-2 are access points (APs) in a wireless LAN. The master device H2-1 and the master device H2-2 operate, as with the slave device N2, in conformity with the IEEE 802.11 standard. Hereafter, the master device H2-1 and the master device H2-2 are collectively referred to as a master device H2.

Hereafter, the present embodiment will be described about the case where, as an example, the master device H2-2 updates a value of the TSF timer to synchronize the clock time of the master device H2-2 with the clock time of the master device H2-1. Note that the master device H2-1 may update the value of the TSF timer to synchronize the clock time of the master device H2-1 with the clock time of the master device H2-2, and both the master devices may have a function of updating the values of the TSF timers, or only one of the master devices may have the function of updating the value of the TSF timer.

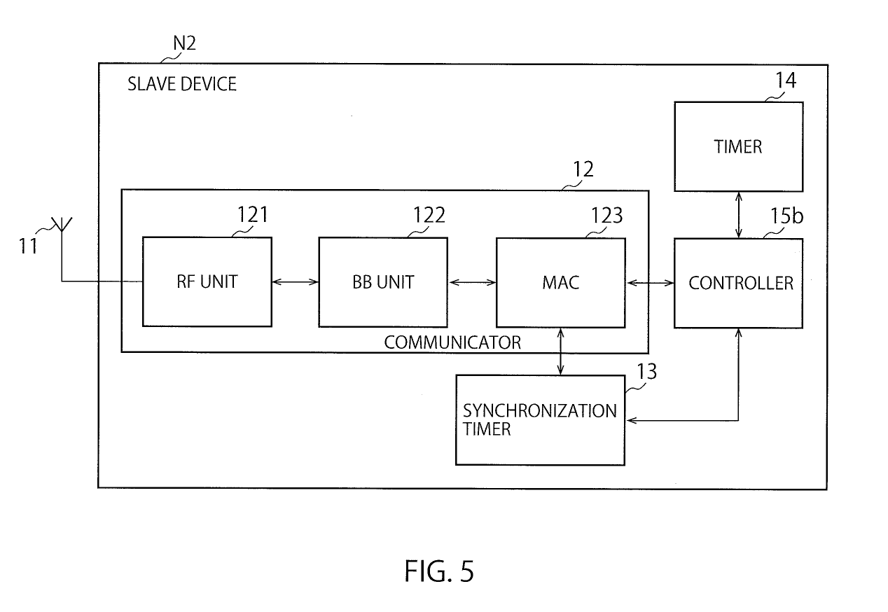

Next, the configuration of the slave device N2 in the second embodiment will be described with reference to FIG. 5. FIG. 5 is a diagram showing the configuration of the slave device N2 in the second embodiment. Note that components identical to those in FIG. 2 are denoted by the same reference characters, and will not be described specifically. The configuration of the slave device N2 in the second embodiment is a configuration, with respect to the configuration of the slave device N1 in the first embodiment, in which the controller 15 is changed to a controller 15b.

In the present embodiment, the first radio resource information is a first clock time kept by the master device (first relay device) H2-1, and the second radio resource information is a second clock time kept by the master device (second relay device) H2-2.

The controller 15b creates a clock time difference Δ₁₂ between the first clock time t₁ and the second clock time t₂ as control information, and causes the communicator 12 to transmit this clock time difference Δ₁₂ to the master device (second relay device) H2-2 that changes the second clock time using this clock time difference Δ₁₂.

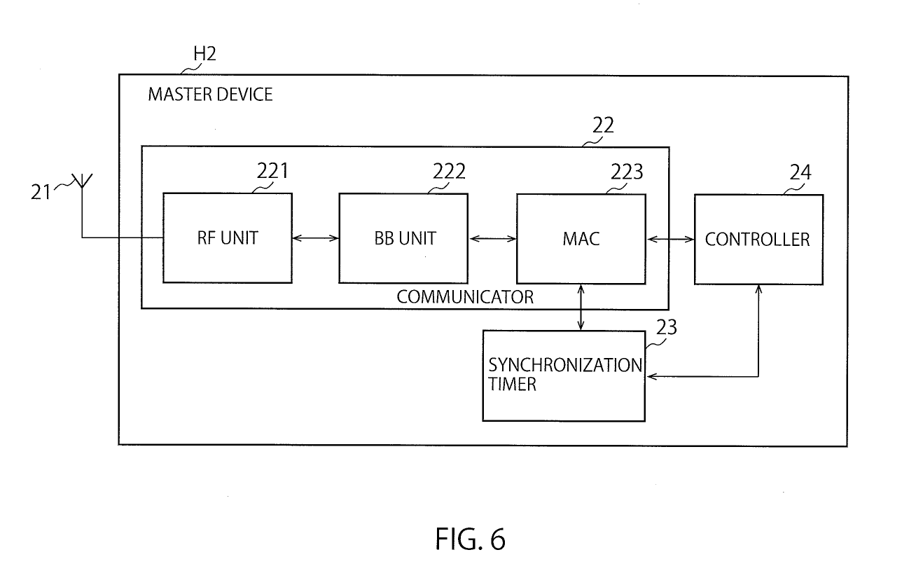

Next, the configuration of the master device H2 in the second embodiment will be described with reference to FIG. 6. FIG. 6 is a diagram showing the configuration of the master device H2 in the second embodiment. As shown in FIG. 6, the master device H2 includes an antenna 21, a communicator 22, a synchronization timer 23, and a controller 24. The communicator 22, the synchronization timer 23, and the controller 24 can be implemented by circuitry such as a processor or an integrated circuit. Each circuitry which implements the communicator 22, the synchronization timer 23, and the controller 24 may be different physical circuitry or all or a part of them may be same physical circuitry.

The communicator 22 communicates with slave devices within its coverage area via the antenna 21. For example, the communicator 22 acquires a control signal that is created by the slave device N2 using a signal acquired by the slave device N2 through wireless communication from the master device H2-1 forming a wireless network different from the wireless network formed by the device in question, from the slave device N2 through wireless communication.

Here, the communicator 22 includes an RF unit 221, a BB unit 222, and a MAC 223. The function of the RF unit 221 is similar to that of the RF unit 121 in the first embodiment, and will not be described. Similarly, the function of the BB unit 222 is a similar to that of the BB unit 122 in the first embodiment, and will not be described.

The MAC 223 performs access timing control similar to that performed by the MAC 123 included in the slave device N1 in the first embodiment, as well as connection management and time synchronization. Here, the connection management is the management of a slave device or message exchange with the slave device under an appropriate authentic method and encryption system of the IEEE 802.11 standard. The time synchronization, as a master device side function specified in the TSF, is processing of writing the value of the TSF timer counted up by the synchronization timer 23, as a time stamp, into a beacon frame to be transmitted.

The synchronization timer 23 counts up the value of the TSF timer (a synchronization timer value).

The controller 24 has a function specified in the IEEE 802.11 standard, the function relating to setting and control of a wireless link. In addition, the controller 24 changes information on the radio resources of a wireless network based on the control information. Here, the present embodiment, this control information contains a clock time difference Δ₁₂ between a clock time kept by the master device in question and a clock time kept by the other master device that forms a wireless network different from the wireless network formed by the master device in question. Then, the controller 24 updates the value of the TSF timer (the synchronization timer value) that is counted up by the synchronization timer 23 based on this difference Δ₁₂.

The controller 24 includes a processor such as a CPU, a memory such as RAM, a storage, and the like, which are not shown, and implements the above-described process by the CPU reading out a program stored in the storage onto the RAM and executing the program. For example, the controller 24 performs a process in accordance with the control information acquired by the communicator 22.

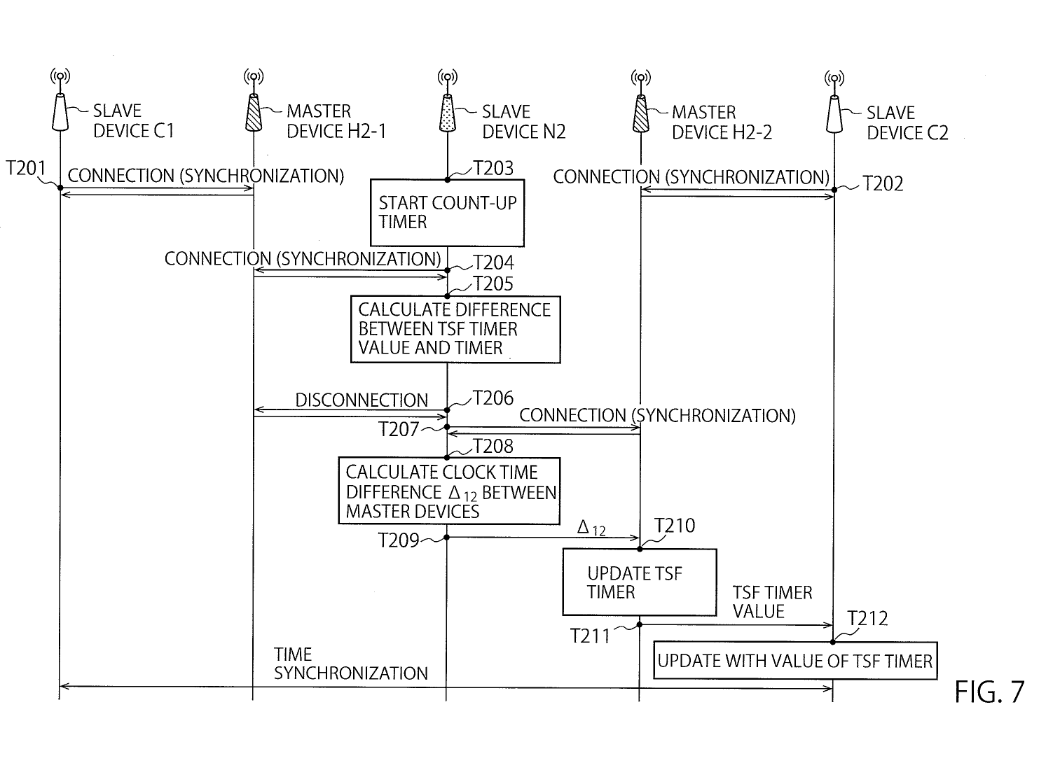

Next, there will be described with reference to FIG. 7 a method of synchronizing a clock time between the slave device C1 and the slave device C2 that belong to different BSSes in the second embodiment. FIG. 7 is a sequence diagram of the process of synchronizing a clock time between the slave device C1 and the slave device C2 in the second embodiment.
(T201) First, the slave device C1 establishes a connection to the master device H2-1. Then, the values of the TSF timers are synchronized between the slave device C1 and the master device 2-1 by the TSF.
(T202) Next, the slave device C2 establishes a connection to the master device H2-2. Then, the values of the TSF timers are synchronized between the slave device C2 and the master device H2-2 by the TSF.
(T203) Next, the controller 15b of the slave device N2 causes the timer 14 to start as a count-up timer. This causes the timer 14 to count up.
(T204) Next, the communicator 12 of the slave device N2 establishes a connection to the master device H2-1. When the connection to master device H2-1 is established, the MAC 123 of the slave device N2 synchronizes the value of the TSF timer of the slave device N2 with that of the master device H2-1 as described above.
(T205) Next, the controller 15b of the slave device N2 calculates a difference δ₁=t₁−t between a value of the TSF timer t₁ and a value t of the operating count-up timer.
(T206) Next, the communicator 12 of the slave device N2 disconnects the connection to the master device H2-1.
(T207) Next, the communicator 12 of the slave device N2 establishes a connection to the master device H2-2. When the connection to the master device H2-2 is established, the MAC 123 of the slave device N2 synchronizes the value of the TSF timer of the slave device N2 with that of the master device H2-2 as described above.
(T208) Next, the controller 15b of the slave device N2 calculates a difference δ₂=t₂−t between a value of the TSF timer t₂ and a value t of the count-up timer. Then, the controller 15b of the slave device N2 calculates a clock time difference Δ₁₂=δ₁−δ₂=t₁−t₂ between a clock time kept by the master device H2-1 and a clock time kept by the master device H2-2.
(T209) Next, the controller 15b of the slave device N2 causes the communicator 12 to transmit information indicating the clock time difference Δ₁₂ to the master device H2-2.
(T210) Next, when the communicator 22 receives the information indicating the clock time difference Δ₁₂, the controller 24 of the master device H2-2 updates the value of the TSF timer that is counted up by the synchronization timer 23 in such a manner as to add the clock time difference Δ₁₂ to the current value of the TSF timer.
(T211) Next, the controller 24 of the master device H2-2 causes the communicator 22 to transmit the information indicating the value of the TSF timer to the slave device C2.
(T212) Next, the slave device C2 updates the value of the TSF timer thereof with the value of the TSF timer received from the master device H2-2. This makes the value of the TSF timer of the slave device C1 identical to the value of the TSF timer of the slave device C2. The clock time of the slave device C1 and the clock time of the slave device C2 are therefore synchronized, which allows the slave device C1 and the slave device C2 to perform synchronized operations based on this time.

Note that FIG. 7 shows the example of synchronizing the values of the TSF timers between the slave device C1 and the slave device C2, and the values of the TSF timers of the master device H2-1 and the master device H2-2 are made identical to each other, which synchronizes the times between the master device H2-1 and the master device H2-2.

As described above, in the slave device N2 in the second embodiment, the controller 15b creates the clock time difference between the first clock time kept by the master device H2-1 and the second clock time kept by the master device H2-2 as control information, and causes the communicator 12 to transmits this clock time difference to the master device H2-2.

In the master device H2-2 in the second embodiment, the communicator 22 acquires this clock time difference from the slave device N2 through wireless communication. Then, the controller 24 updates the synchronization timer value that is counted up by the synchronization timer 23 based on this clock time difference.

The times of master device H2-1 and the master device H2-2 can be thereby synchronized. Therefore, the times of the slave device C1 connected to the master device H2-1 and the slave device C2 connected to the master device H2-2 can be synchronized.

### Third Embodiment

Next, a third embodiment will be described. In the second embodiment, the times of the master device H2-1 and the master device H2-2 are synchronized by changing the clock time of the master device H2-2 using the clock time difference between the first clock time kept by the master device H2-1 and the second clock time kept by the master device H2-2. In contrast thereto, in the third embodiment, radio information on a radio wave used for wireless communication used by a plurality of master devices is notified to a third master device via a slave device, and the third master device determines a frequency used for the wireless communication using this information. It is thereby possible to reduce radio wave interference.

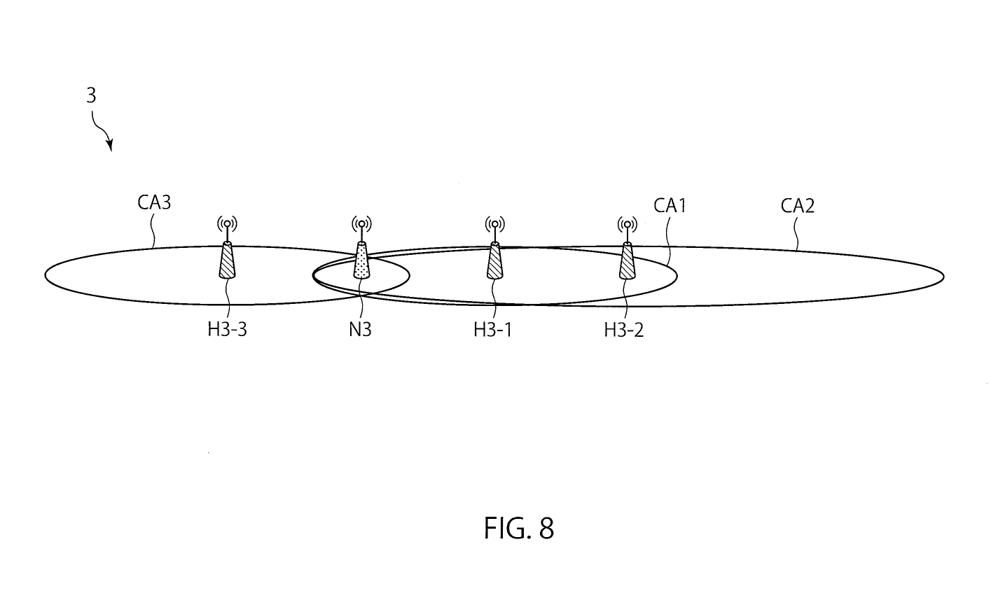

Next, the configuration of a communicating system 3 in the third embodiment will be described with reference to FIG. 8. FIG. 8 is a diagram showing the configuration of the communicating system 3 in the third embodiment. As shown in FIG. 8, the communicating system 3 includes a master device (first relay device) H3-1, a master device (first relay device) H3-2, a master device (second relay device) H3-3, and a slave device N3. In the present embodiment, as an example, the description will be made below assuming that the master device H3-1, the master device H3-2, the master device H3-3, and the slave device N3 are positioned in a fixed manner.

The master device H3-1, the master device H3-2, and the master device H3-3 have a function as hubs in a star network and are communication devices that operate as the hubs in the star network. In the present embodiment, as an example thereof, the description will be made assuming that the master device H3-1, the master device H3-2, and the master device H3-3 are access points (APs) in a wireless LAN.

As shown in FIG. 8, the master device H3-1 forms a first wireless network and has a coverage area CA1. In contrast, the master device H3-2 forms a second wireless network that is different from the first wireless network and has a coverage area CA2. That is, the master device H3-1 and the master device H3-2 form BSSes (Basic Service Sets) independent from each other. The configurations of the master device H3-1 and the master device H3-2 are similar to that of a conventional access point in a wireless LAN, and will not be described in detail.

The master device H3-3 forms a third wireless network that is different from the first wireless network and the second wireless network, and has a coverage area CA3.

The slave device N3 is positioned within the three coverage areas, the coverage area CA1, the coverage area CA2, and the coverage area CA3. That is, the slave device N3 is disposed at a position at which beacon frames from the master device H3-1 and the master device H3-2 can be received, and is positioned within a range in which wireless communication can be performed with the master device H3-3. The slave device N3 in the present embodiment is a communication device that is wirelessly connected to a hub in a star network, and is called a Station or an STA in a wireless LAN.

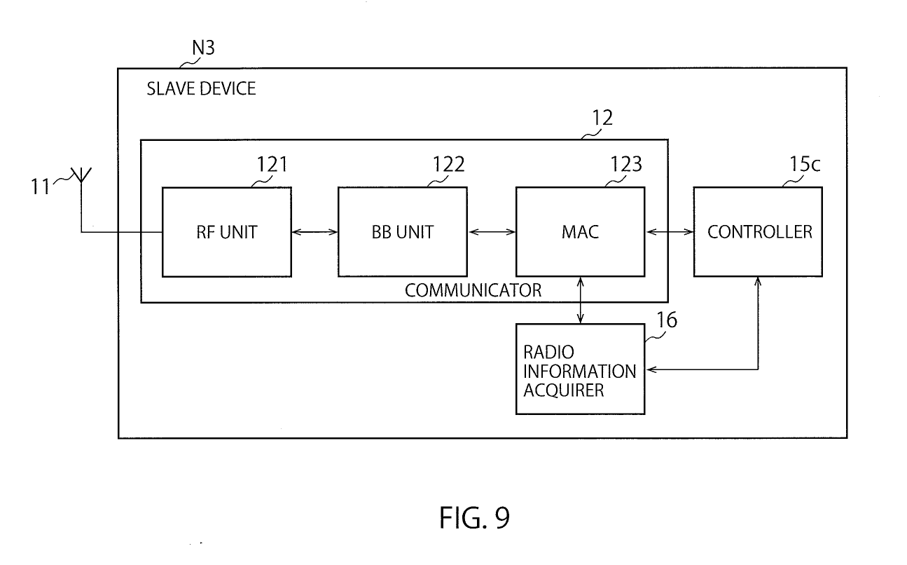

Next, the configuration of the slave device N3 in the third embodiment will be described with reference to FIG. 9. FIG. 9 is a diagram showing the configuration of the slave device N3 in the third embodiment. Note that components identical to those in FIG. 2 are denoted by the same reference characters, and will not be described specifically. The configuration of the slave device N3 in the third embodiment is a configuration, with respect to the configuration of the slave device N1 in the first embodiment, in which the controller 15 is changed to a controller 15c, a radio information acquirer 16 is added, and the synchronization timer 13 and the timer 14 are eliminated. The components of the slave device N3 other than the radio information acquirer 16 operate in conformity with the IEEE 802.11 standard.

The MAC 123 performs access timing control and connection processing similar to those by the MAC 123 of the slave device N1 in the first embodiment.

The radio information acquirer 16 acquires radio information on a radio wave at the time of receiving a first signal from the first relay device forming the first wireless network. For example, the radio information acquirer 16 acquires radio information on a radio wave used by the master device H3-1 for wireless communication and radio information on a radio wave used by the master device H3-2 for wireless communication. Here, the radio information contains channel information indicating a frequency used for the wireless communication (hereafter, referred to as a channel), and/or power reception information indicating the received power of a received beacon frame (Received Signal Strength Indicator: RSSI).

For example, the radio information acquirer 16 acquires the usage status of a channel as channel information by a BSSID (Basic Service Set Identifier) or an SSID (Service Set Identifier) with a channel scanning function, and stores the acquired channel information. Hereafter, the BSSID and the SSID are collectively called an SS identifier.

With the channel scanning function, the communicator 12 receives a beacon frame, and the radio information acquirer 16 acquires a channel number in active use. Note that the communicator 12 may receive a frame other than the beacon frame for this purpose.

In addition, the radio information acquirer 16 may store, by channel, the number of SS identifiers that use the channel in question (hereafter, referred to as a by-channel SS identifiers number), or may store all the combinations of SS identifiers and received powers by channel. Alternatively, the radio information acquirer 16 may store the combination of an SS identifier having a maximum received power and the received power by channel. Alternatively, the radio information acquirer 16 may sort, by channel, SS identifiers using the channel in a descending order of received power, and store the combination of prescribed number of top SS identifiers and the total sum of the received powers. Alternatively, the radio information acquirer 16 may store, by channel, the sum of the received powers of beacon frames received on the channel (hereafter, referred to as a by-channel received power sum).

In addition, the radio information acquirer 16 in the present embodiment separately store SS identifiers having received powers higher than or equal to a prescribed threshold value, for example, in the form of a list in order to detect a master device that is newly started.

In such a manner, the controller 15c creates, using first radio information on a radio wave at the time of receiving the above first signal, radio information containing the usage status of a frequency to be used for wireless communication or the received power of this first signal, as control information. Then, the controller 15c causes the communicator 22 to transmit this radio information to the master device H3-3 that determines a frequency to be used for wireless communication based on this radio information.

For example, in the case where the first radio information is a frequency used by the master device H3-1 and/or the master device H3-2 for wireless communication, the controller 15c may calculate, using this frequency, the number of communication devices that use the frequency for the wireless communication as control information for each frequency.

As another example, in the case where the first radio information is the received power of a beacon signal acquired from the master device H3-1 and/or the master device H3-2, the controller 15c may calculate, using this received power, information on received power at each frequency (e.g., the sum of received powers by channel) as control information.

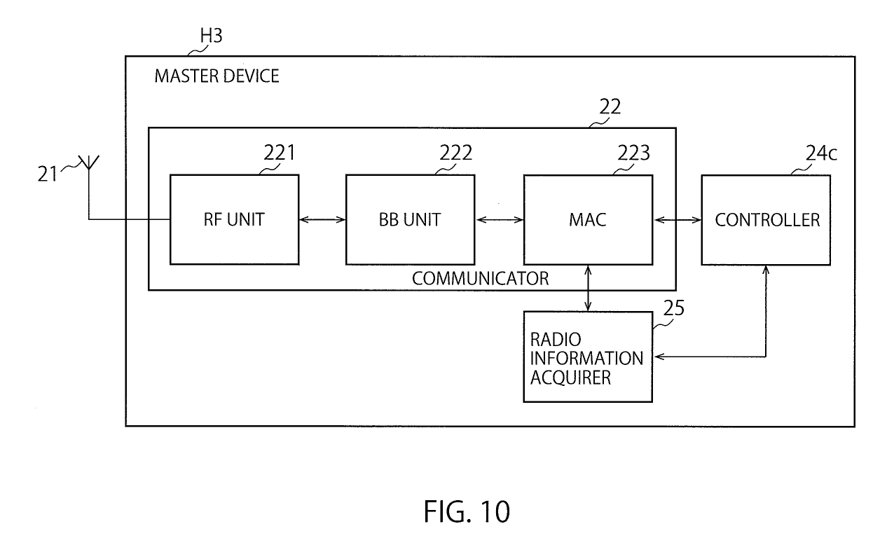

Next, the configuration of the master device H3 in the third embodiment will be described with reference to FIG. 10. FIG. 10 is a diagram showing the configuration of the master device H3 in the third embodiment. Note that components identical to those in FIG. 6 are denoted by the same reference characters, and will not be described specifically. The configuration of the master device H3 in the third embodiment is a configuration, with respect to the configuration of the master device H2 in the second embodiment in FIG. 6, in which the controller 24 is changed to a controller 24c, a radio information acquirer 25 is added, and the synchronization timer 23 is eliminated. The components of the master device H3-3 other than the radio information acquirer 25 operate in conformity with the IEEE 802.11 standard.

The communicator 22 acquires radio information transmitted from the slave device N3 through wireless communication. Note that the MAC 223 included in the communicator 22 performs access timing control similar to that by the MAC 123 of the slave device N1 in the first embodiment, and has a connection managing function.

The radio information acquirer 25 acquires the radio information acquired by the communicator 22, from the MAC 223 of the communicator 22, and stores the acquired radio information. Note that if a received power for each channel is received from a plurality of slave devices as an example of the radio information, the radio information acquirer 25 may total up received powers by channel, and may store the sum of totaled received powers.

The controller 24c determines the frequency to be used for the wireless communication using this radio information.

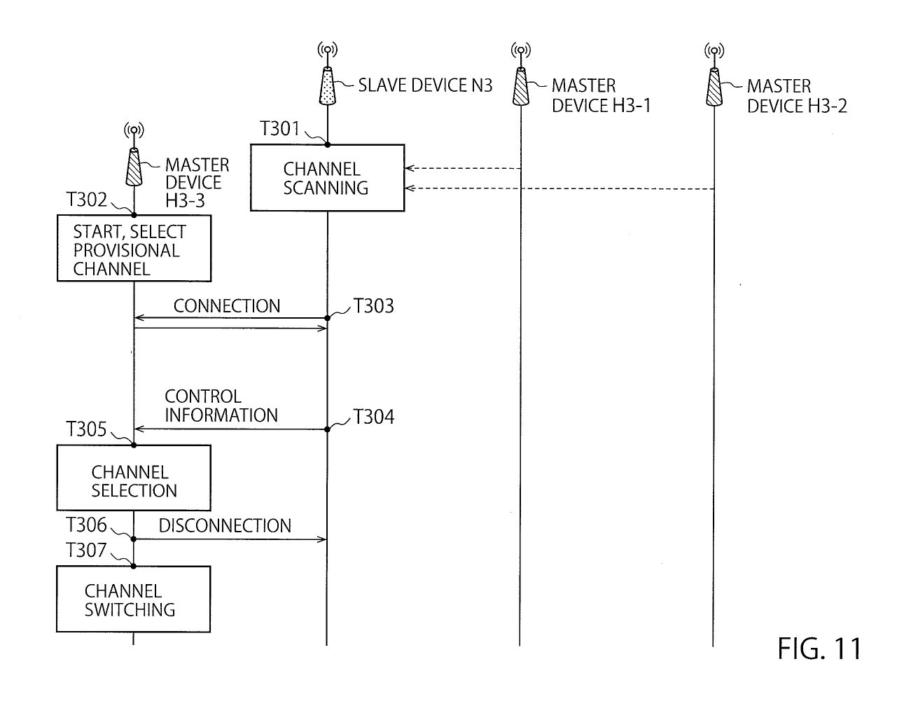

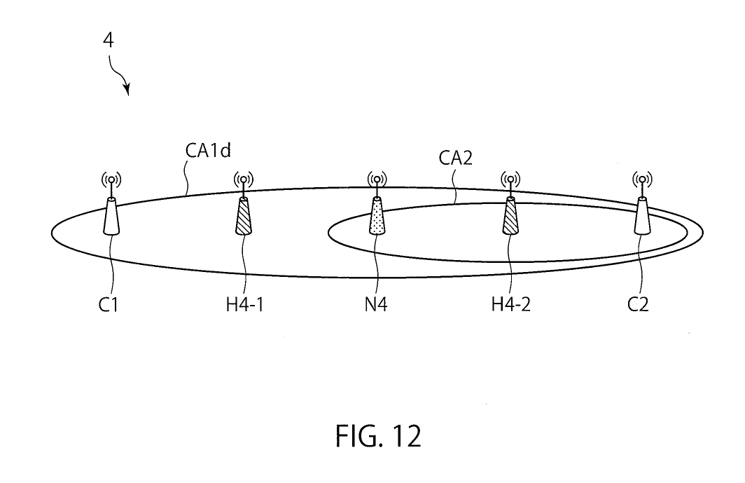

Next, the control of the slave device N3 and the master device H3-3 in the third embodiment will be described with reference to FIG. 11. FIG. 11 is a sequence diagram of the control of the slave device N3 and the master device H3-3 in the third embodiment.
(T301) The slave device N3 performs channel scanning and store radio information. The channel scanning can be normally performed even when there is no connection to the master devices. Here, for example, the slave device N3 receives beacon frames transmitted by the master device 1 and the master device 2, respectively, and stores the channel numbers used by the master device 1 and the master device 2 and the received powers of the respective transmitted beacon frames.
(T302) Here, assume a situation where the master device H3-3 is newly started. The communicator 12 of the slave device N3 periodically performs the channel scanning, the radio information acquirer 16 of the slave device N3 stores, as described above the SS identifiers having received powers higher than or equal to the prescribed threshold value in the form of a list. The controller 15c of the slave device N3 can grasp the operation circumstances of surrounding master devices based on a change in this list.

Specifically, the master device H3-3 is newly started. Then, the controller 24c of the master device H3-3 provisionally selects a channel, and the communicator 22 of the master device H3-3 transmits a beacon frame using the selected channel. At this point, the controller 15c of the slave device N3 can detect the newly started master device H3-3 by the addition of a new SS identifier to the list.
(T303) Then, the communicator 12 of the slave device N3 establishes a connection to the master device H3-3.
(T304) Then, the communicator 12 of the slave device N3 transmits the radio information to the master device H3-3.

Here, the radio information is information stored in the above-described radio information acquirer 16 of the slave device N3. It is preferable that the received power from the master device H3-3 is excluded from the radio information transmitted to the master device H3-3 by the slave device N3.
(T305) Next, the communicator 22 of the master device H3-3 receives the radio information. Then, the radio information acquirer 25 of the master device H3-3 stores the radio information received by the communicator 22. Then, the controller 24c of the master device H3-3 determines a frequency (channel) to be used for wireless communication using the radio information received by the communicator 22. At this point, the controller 24c of the master device H3-3 may select a channel having a minimum number of channel SS identifiers by channel, or may select a channel having a minimum sum of received powers by channel.

Note that the selecting method of a channel is not limited to them, and may be any selecting method by which the use of the selected channel makes radio wave interference small.
(T306) Here, assume the case where the master device H3-3 selects a channel other than the channel provisionally used in step S305. In this case, the communicator 22 of the master device H3-3 disconnects the connection to the slave device N3.
(T307) Then, the controller 24c of the master device H3-3 switches a channel used for wireless communication from the provisionally used channel to the channel selected in step S305.

Note that the master device H3-3 may not be newly started, but may transmit a message (not shown) to request radio information. In this case, the slave device N3 may perform the channel scanning on the message and transmit radio information.

In addition, the master device H3-3 may acquire the radio information from the slave device N3 as described above by stopping the transmission of a beacon frame for a period longer than a time interval at which the slave device N3 performs the channel scanning on and restarting the transmission to pretend to be newly started.

As described above, in the third embodiment, the controller 15c of the slave device N3 creates, using the first radio information on a radio wave at the time of receiving the first signal, radio information containing the usage status of a frequency to be used for wireless communication or the received power of the first signal, as control information, and causes the communicator 12 to transmit this radio information to the master device H3-3.

Then, the controller 24c of the master device H3-3 determines a frequency to be used for the wireless communication using this radio information. The controller 24c of the master device H3-3 can thereby perform the wireless communication using a frequency with which radio interference is reduced.

### Fourth Embodiment

Next, a fourth embodiment will be described. In the third embodiment, a slave device determines radio information containing usage statuses or received powers by frequency (channel), and a newly started master device determines a frequency to be used for wireless communication using this radio information. In contrast thereto, in the fourth embodiment, a slave device judges whether to distribute communication loads between two master devices, and if determining to distribute the communication loads based on the result of judgment, the slave device causes the connection destination of some terminal devices connected to a master device having a heavier communication load to be switched to a master device having a lighter communication load. It is thereby possible to distribute communication loads between two master devices.

Next, the configuration of a communicating system 4 in the fourth embodiment will be described with reference to FIG. 12. FIG. 12 is a diagram showing the configuration of the communicating system 4 in the fourth embodiment. Note that components identical to those in FIG. 4 are denoted by the same reference characters, and will not be described specifically. The configuration of the communicating system 4 in the fourth embodiment is a configuration, with respect to the configuration of the communicating system 2 in the second embodiment, in which the slave device N2 is changed to a slave device N4, the master device H2-1 is changed to a master device (first relay device) H4-1, and the master device H2-2 is changed to a master device (second relay device) H4-2. In the present embodiment, as an example, the description will be made below assuming that the master device H4-1, the master device H4-2, the slave device N4, and the slave devices Cl and C2 are positioned in a fixed manner.

As shown in FIG. 12, the master device H4-1 forms a first wireless network and has a coverage area CA1d. In contrast, the master device H4-2 forms a second wireless network that is different from the first wireless network and has a coverage area CA2. The slave device N4 is positioned within both of the coverage area CA1d and the coverage area CA2, and can wirelessly communicate with both of the master device H4-1 and the master device H4-2. The slave device C1 is positioned within the coverage area CA1d, and can wirelessly communicate with the master device H4-1. The slave device C2 is positioned within both of the coverage area CA1d and the coverage area CA2, and can wirelessly communicate with both of the master device H4-1 and the master device H4-2. Hereafter, the master device H4-1 and the master device H4-2 are collectively referred to as a master device H4.

Hereafter, the present embodiment will be described about an example in which the master device H4-1 transmits a connection destination switching request to the slave device C2 in response to an offload request. Note that, unlike FIG. 12, if the slave device C1 is positioned within the coverage area of the master device H4-2, the master device H4-2 may transmit a connection destination switching request to the slave device C1 in response to an offload request, and both the master devices may have a function of transmitting a connection destination switching request, or only one of the master devices may have the function of transmitting a connection destination switching request.

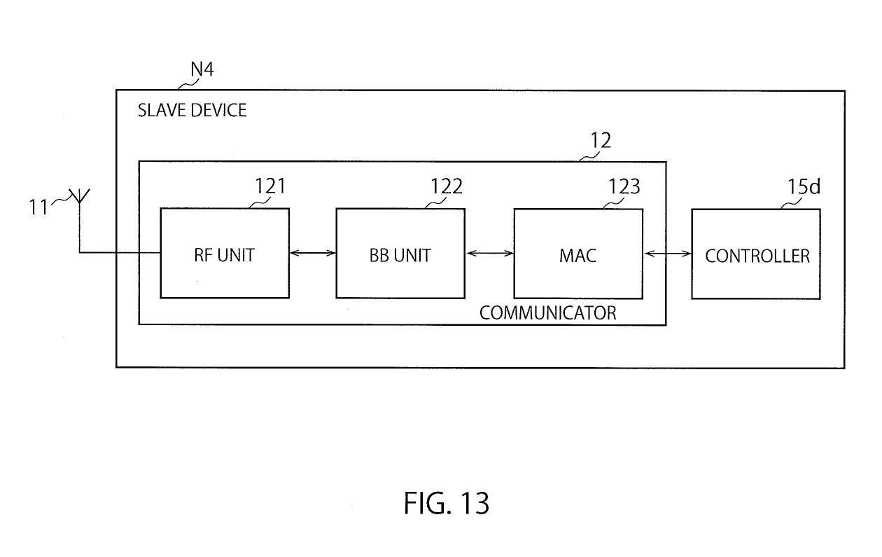

Next, the configuration of the slave device N4 in the fourth embodiment will be described with reference to FIG. 13. FIG. 13 is a diagram showing the configuration of the slave device N4 in the fourth embodiment. Note that components identical to those in FIG. 5 are denoted by the same reference characters, and will not be described specifically.

The configuration of the slave device N4 in the fourth embodiment is a configuration, with respect to the configuration of the slave device N2 in the second embodiment, in which the controller 15b is changed to a controller 15d, and the synchronization timer 13 and the timer 14 are eliminated. All the components of the slave device N4 operate in conformity with the IEEE 802.11 standard. Note that the controller 15d further has an additional function, which will be described hereafter.

In the present embodiment, the first radio resource information is first traffic information on traffic on the first wireless network. Here, the first traffic information is, for example, information on the communication volume in the first wireless network, or information on the number of communication devices connected to the first wireless network.

In addition, in the present embodiment, second radio resource information is second traffic information on traffic on the second wireless network. Here, the second traffic information is, for example, information on the communication volume in the second wireless network, or information on the number of communication devices connected to the second wireless network.

The controller 15d judges whether to distribute communication loads between the master device H4-1 and the master device H4-2 using the first traffic information and the second traffic information. Then, if the communication loads are to be distributed based on the result of judgment, the controller 15d creates information, as the above control information, to change the connection destination of some terminal devices, which are connected to one communication device that has a heavier communication load out of the master device H4-1 and the master device H4-2, to the other communication device.

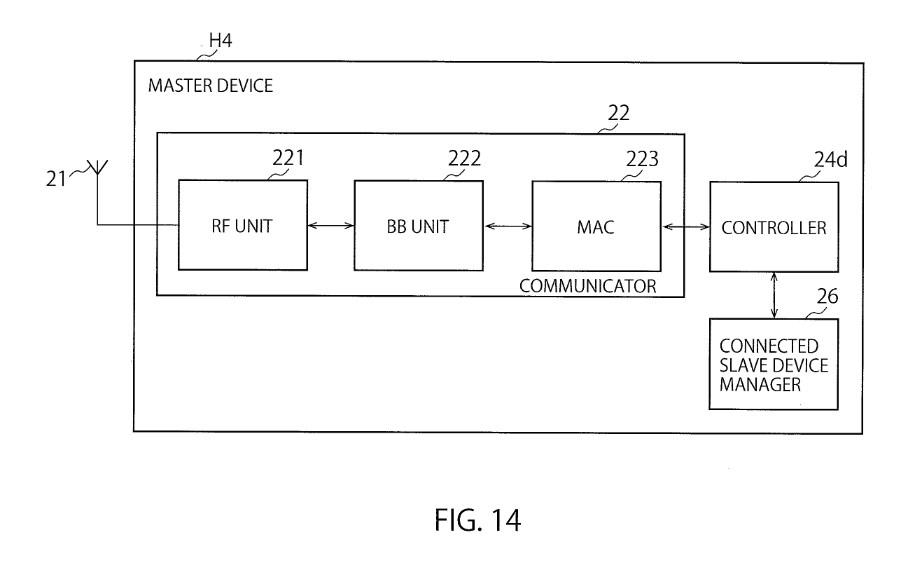

Next, the configuration of the master device H4 in the fourth embodiment will be described with reference to FIG. 14. FIG. 14 is a diagram showing the configuration of the master device H4 in the fourth embodiment. Note that components identical to those in FIG. 6 are denoted by the same reference characters, and will not be described specifically.

The configuration of the master device H4 in the fourth embodiment is a configuration, with respect to the configuration of the master device H2 in the second embodiment, in which the controller 24 is changed to a controller 24d, the synchronization timer 13 is eliminated, and a connected slave device manager 26 is added. All blocks of the components of the master device H4 other than the connected slave device manager 26 operate in conformity with the IEEE 802.11 standard. The controller 24d further has an additional function, which will be described hereafter.

The control information in the present embodiment is an offload request containing information to identify a terminal device (slave device), the connection destination of which should be switched. The controller 24d transmits a connection destination switching request to request to switch the connection destination to a terminal device (e.g., the slave device C2) that is specified by terminal identification information contained in an offload request received by the communicator 22. This connection destination switching request is a signal to request to switch the connection destination of the terminal device (e.g., the slave device C2), the connection destination of which should be switched, from a master device (e.g., the master device H4-1) having a heavier communication load to a master device (e.g., the master device H4-2) having a lighter communication load.

The connected slave device manager 26 performs a process of managing connected slave devices.

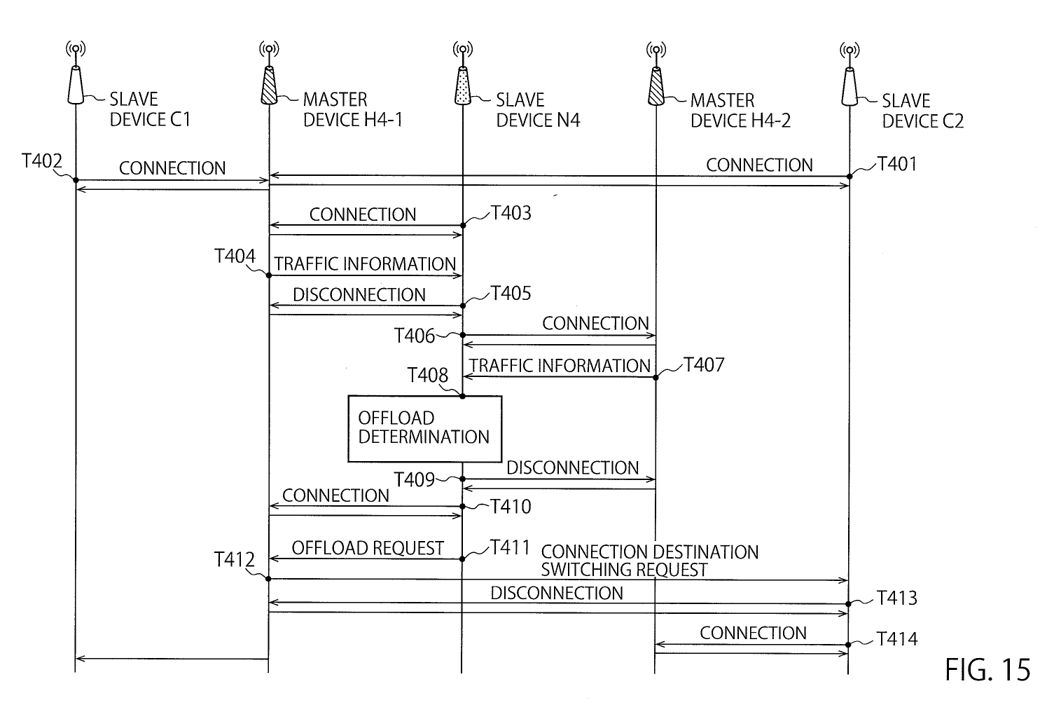

Next, there will be described with reference to FIG. 15 a process among the controller 15d of the slave device N4, and the controller 24d and the connected slave device manager 26 of the master device H4 in the fourth embodiment. FIG. 15 is a sequence diagram showing an example of a process by the communicating system 4 in the fourth embodiment.
(T401) First, the slave device C2 establishes a connection to the master device H4-1.
(T402) Next, the slave device C1 establishes a connection to the master device H4-1.
(T403) Next, the communicator 12 of the slave device N4 establishes a connection to the master device H4-1.
(T404) Next, the controller 15d of the slave device N4 acquires traffic information from the master device H4-1 via the communicator 12 through wireless communication. Here, the traffic information is the number of slave devices connected to the master device H4-1 and/or the throughputs of the slave devices.
(T405) Next, the communicator 12 of the slave device N4 disconnects the connection to the master device H4-1.
(T406) Next, the communicator 12 of the slave device N4 establishes a connection to the master device H4-2.
(T407) Next, the controller 15d of the slave device N4 acquires traffic information from the master device H4-2 via the communicator 12 through wireless communication. In such a manner, the controller 15d of the slave device N4 in the fourth embodiment acquires traffic information from two or more master devices.
(T408) Next, the controller 15d of the slave device N4 performs offload determination. The offload determination is to determine whether to distribute communication loads on a master device among BSSes, that is, a plurality of wireless networks. For example, in the case where the throughput of one master device is lower than or equal to a threshold value while the throughput of the other master device reaches its upper limit, the controller 15d of the slave device N4 determines to change the connection destination of some of a plurality of slave devices connected to the former master device to the latter master device.

In addition, for example, when one master device has the number of slave device connections that is larger than or equal to the predetermined threshold value (e.g., the number of slave device connections is close to the upper limit) but the other master device has the number of slave device connections that is smaller than a predetermined threshold value (e.g., the number of slave device connections is within the upper limit of the number of connections), the controller 15d of the slave device N4 determines to change the connection destination of some of a plurality of slave devices connected to the former master device to the latter master device. This allows a new slave device to establish a connection to the former master device. This traffic information being a criterion of the offload determination preferably contains pieces of throughput information on connected slave devices, the throughput upper limit value of a master device, and the current number of slave device connections and/or the upper limit of the number of slave device connections.

Hereafter, assume the case where it is determined that communication loads on a master device should be distributed as a result of offload determination performed by the slave device N4.
(T409) The controller 15d of the slave device N4 disconnects the connection to the master device H4-2.
(T410) Then, the controller 15d of the slave device N4 establishes a connection to the master device H4-1 to which the slave device C2, the connection destination of which being the master device should be switched, is currently connected.
(T411) Then, the controller 15d of the slave device N4 notifies an offload request containing the terminal identification information to identify the slave device C2 to be offloaded, to the master device H4-1.
(T412) The controller 24d of the master device H4-1 receiving this offload request transmits a connection destination switching request from the communicator 22 to the slave device C2.
(T413) Next, upon receiving the connection destination switching request, the slave device C2 disconnects the connection to the master device H4-1.
(T414) Then, the slave device C2 establishes a connection to the master device H4-2.

In such a manner, the controller 15d of the slave device N4 specifies the slave device C2 disposed within the above overlapped area as a terminal device, the connection destination of which should be switched, and creates an offload request containing terminal identification information to identify this specified terminal device as control information. Then, the controller 15d of the slave device N4 causes the communicator 12 to transmit this offload request to a communication device having a heavier communication load out of the master device H4-1 and the master device H4-2 (here, as an example, the master device H4-1).

Note that the connection destination switching request is not necessarily wirelessly transmitted by the master device H4-1, and the slave device N4 may wirelessly transmit the connection destination switching request to the slave device C2 via the master device H4-1 while being connected to the master device H4-1. That is, the controller 15d may specify the slave device C2 being a terminal device disposed within the above overlapped area as a terminal device the connection destination of which should be switched, create a connection destination switching request to request to switch the connection destination as the above control information, and cause the communicator 12 to transmit this connection destination switching request to this specified terminal device.

Note that the offload determining function of the slave device N4 and the connection destination switching function of the slave device C2 may not be implemented in the same slave device. That is, a slave device having the offload determining function and a slave device that can perform connection destination switching in response to the connection destination switching request may be separate slave devices having different roles or functions.

As described above, in the fourth embodiment, the controller 15d of the slave device N4 judges whether to distribute communication loads between the master device H4-1 and the master device H4-2 using the first traffic information and the second traffic information. When the communication loads are to be distributed based on the result of judgement, the controller 15d of the slave device N4 specifies the slave device C2 being a terminal device disposed within the overlapped area as a terminal device the connection destination of which should be switched, creates an offload request containing terminal identification information to identify the specified terminal device as control information, and causes the communicator 12 to transmit this offload request to the master device H4-1 being a communication device that has a heavier communication load out of the master device H4-1 and the master device H4-2.

Then, the controller 15d of the master device H4-1 transmits a connection destination switching request to request to switch the connection destination to a terminal device specified by the terminal identification information contained in this offload request. The terminal device receiving the connection destination switching request thereby switches the connection destination, which allows communication loads to be distributed between the master device H4-1 and the master device H4-2.

### Fifth Embodiment

Next, a fifth embodiment will be described. In the fifth embodiment, a slave device that is positioned within the coverage areas of a plurality of wireless networks switches, upon receiving a routing formation packet from a first master device, to a second master device being a connection destination, and transmits this routing formation packet to the second master device. Upon receiving the routing formation packet, the second master device broadcasts this routing formation packet to slave devices that are connected to a wireless network formed by itself. It is thereby possible, in an environment where a plurality of wireless networks exist, to transport data across the plurality of wireless networks, enabling data to be transported over a wide area.

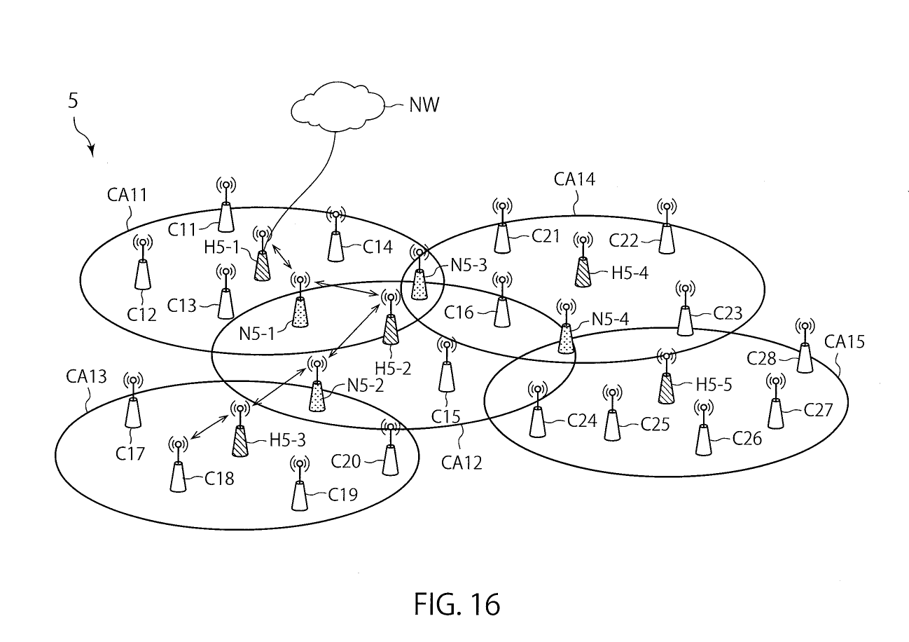

Next, the configuration of a communicating system 5 in the fifth embodiment will be described with reference to FIG. 16. FIG. 16 is a diagram showing the configuration of the communicating system 5 in the fifth embodiment. As shown in FIG. 16, the communicating system 5 includes master devices H5-1, H5-2, H5-3, H5-4, and H5-5, slave devices N5-1, N5-2, N5-3, and N5-4, and slave devices C11, . . . , C28. In the present embodiment, the description will be made below assuming, as an example, that the devices included in the communicating system 5 are positioned in a fixed manner.

The master device H5-1 is connected to an Internet NW, acting as a gateway (Gateway). To be connected to the Internet NW, communication devices other than the master device H5-1 included in the communicating system 5 need to communicate with master device H5-1. The master device H5-1 forms a wireless network having a coverage area CA11. Hereafter, the present embodiment will be described about an example in which the master device H5-1 functions as a gateway and broadcasts a routing formation packet containing number-of-hops information having a value of zero. Hereafter, the master device H5-1 is also referred to as a gateway. Note that the master device H5-1 may not function as a gateway but have a routing function, which will be described hereafter, and in this case, at least one of the other master devices H5-2 to H5-5 may function as a gateway.

Similarly, the master devices H5-2, H5-3, H5-4, and H5-5 form wireless networks having coverage areas CA12, CA13, CA14, and CA15, respectively.

The master devices H5-2 to H5-5 each have a function of relaying and transmitting data as a hub in a star network. Hereafter, the master devices H5-2 to H5-5 are collectively referred to as a master device H5. Hereafter, in the present embodiment, the description will be made assuming that all the master devices H5-2 to H5-5 have the routing function to be described hereafter. Note that at least one of the master devices H5-2 to H5-5 may function as a gateway and broadcast a routing formation packet containing number-of-hops information having a value of zero, and in this case, the master device functions as a gateway may not have the routing function to be described hereafter.

The slave device N5-1 is positioned within both of the coverage area CA11 and the coverage area CA12, and can wirelessly communicate with the master device H5-1 and the master device H5-2.

The slave device N5-2 is positioned within both of the coverage area CA12 and the coverage area CA13, and can wirelessly communicate with the master device H5-2 and the master device H5-3.

The slave device N5-3 is positioned within three coverage areas, the coverage area CA11, the coverage area CA12, and the coverage area CA14, and can wirelessly communicate with the master device H5-1, the master device H5-2, and the master device H5-4.

The slave device N5-4 is positioned within three coverage areas, the coverage area CA12, the coverage area CA14, and the coverage area CA15, can wirelessly communicate with the master device H5-2, the master device H5-4, and the master device H5-5. Hereafter, the slave devices N5-1 to N5-4 are collectively referred to as a slave device N5.

The slave devices C11 to C14 is positioned within the coverage area CA11, and can wirelessly communicate with the master device H5-1. Similarly, the slave devices C15 and C16 are positioned within the coverage area CA12, and can wirelessly communicate with the master device H5-2. Similarly, the slave devices C17 to C20 are positioned within the coverage area CA13, and can wirelessly communicate with the master device H5-3. Similarly, the slave devices C21 to C23 are positioned within the coverage area CA14, and can wirelessly communicate with the master device H5-4. Similarly, the slave devices C24 to C28 are positioned within the coverage area CA15, and can wirelessly communicate with the master device H5-5. The slave devices C11, . . . , C28 are similar to a conventional terminal device that can perform communication in a wireless LAN, and will not be described in detail.

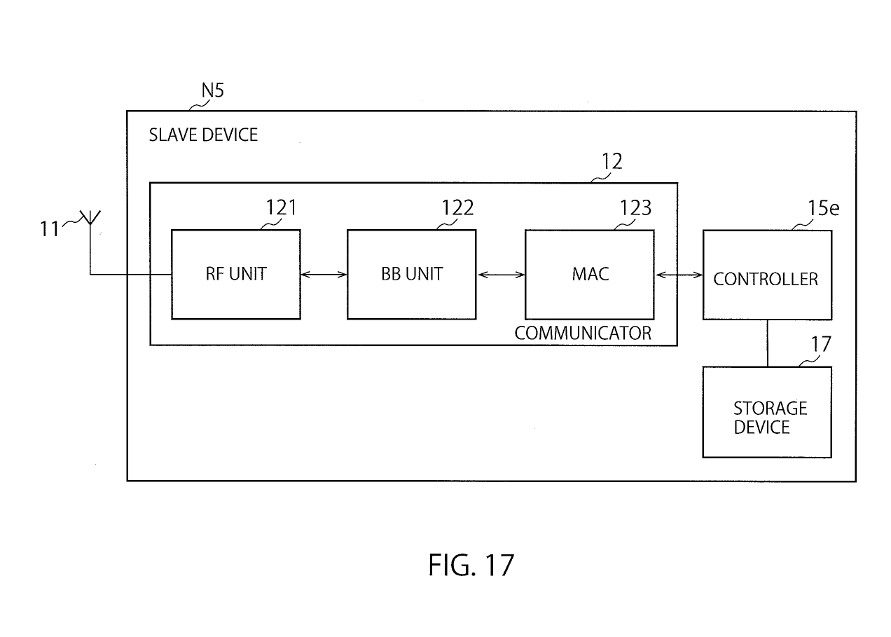

Next, the configuration of the slave device N5 in the fifth embodiment will be described with reference to FIG. 17. FIG. 17 is a diagram showing the configuration of the slave device N5 in the fifth embodiment. Note that components identical to those in FIG. 13 are denoted by the same reference characters, and will not be described specifically.

The configuration of the slave device N5 in the fifth embodiment is a configuration, with respect to the configuration of the slave device N4 in the fourth embodiment, in which the controller 15d is changed to a controller 15e, and a storage device 17 is added. The storage device 17 may a memory such as a NAND, an MRAM and a DRAM or a storage such as an HDD and an SSD. All the components of the slave device N5 operate in conformity with the IEEE 802.11 standard. Note that the controller 15e further has a routing function, which will be described hereafter. Routing is a function to construct a route on which data is relayed and transmitted in the case of communicating with a wireless communication device with which direct communication cannot be performed. Hereafter, routing in minimum hop number reference by flooding will be described as a method of routing.

Here, in the present embodiment, a first signal received by the communicator 12 from a first relay device (e.g., the master device H5-1) contains number-of-hops information indicating a hop count from a gateway connected to the Internet up to the first relay device.

In addition, when the communicator 12 receives first number-of-hops information as the above number-of-hops information, the controller 15e compares a first hop count indicated by this first number-of-hops information with a second hop count indicated by the second number-of-hops information stored in the storage device 17 that is accessible to the slave device N5. Then, if the result of comparison shows that the first hop count is lower than the second hop count, the controller 15e updates the second number-of-hops information stored in the storage device 17 with the first hop count.

Then, the controller 15e stores the address or identifier of a transmission source of the first number-of-hops information in the storage device 17 as the transmission destination of a packet that is addressed to the gateway. Then, the controller 15d creates updated-number-of-hops information indicating a hop count obtained by incrementing the hop count indicated by this first number-of-hops information by one, as control information, and causes the communicator 12 to transmit the updated-number-of-hops information to the second relay device (e.g., the master device H5-2).

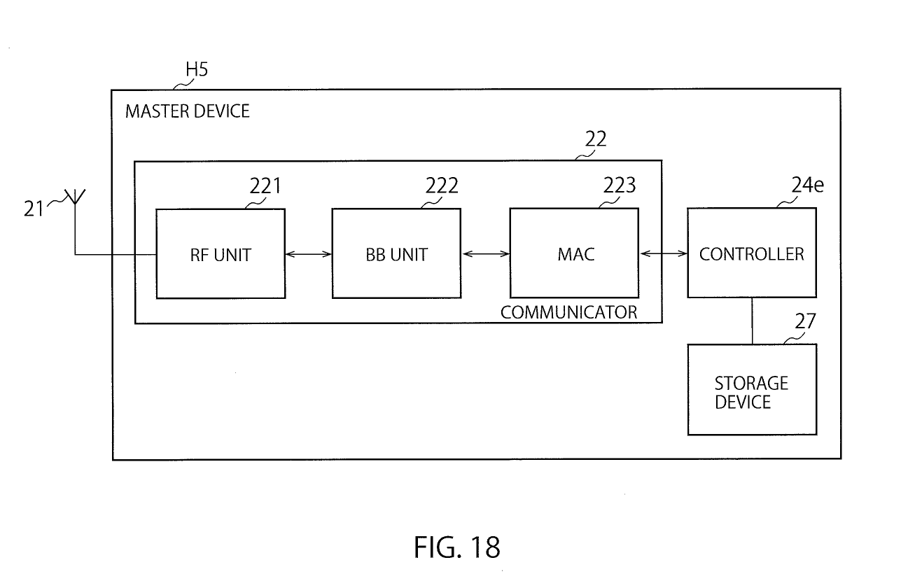

Next, the configuration of the master device H5 in the fifth embodiment will be described with reference to FIG. 18. FIG. 18 is a diagram showing the configuration of the master device H5 in the fifth embodiment. Note that components identical to those in FIG. 14 are denoted by the same reference characters, and will not be described specifically.

The configuration of the master device H5 in the fifth embodiment is a configuration, with respect to the configuration of the master device H4 in the fourth embodiment, in which the controller 24d is changed to a controller 24e, the connected slave device manager 26 is eliminated, and a storage device 27 is added. The storage device 27 may a memory such as a NAND, an MRAM and a DRAM or a storage such as an HDD and an SSD. All the components of the master device H5 operate in conformity with the IEEE 802.11 standard. Note that the controller 24e further has a routing function, which will be described hereafter.

The communicator 22 receives, from a slave device (terminal device) connected to a wireless network formed by the master device H5, a routing formation packet containing the first number-of-hops information that indicates a hop count from the gateway connected to the Internet NW up to the slave device (terminal device).

The controller 24e compares the first hop count indicated by the above first number-of-hops information with the second hop count indicated by the second number-of-hops information stored in the storage device 27.

If the result of comparison shows the first hop count is smaller than the second hop count, the controller 24e updates the second number-of-hops information stored in the storage device 27 with the first hop count. Furthermore, the controller 24e stores the address or identifier of the transmission source of a routing formation packet in the storage device 27 as the transmission destination of a packet that is addressed to the above gateway. Then, the controller 24e causes the communicator 22 to broadcast updated-number-of-hops information that indicates a hop count obtained by incrementing the first hop count indicated by the first number-of-hops information by one.

Next, the flow of routing formation between the master device H5-1 and the slave device C18 will be described with reference to FIG. 16.

The master device H5-1 broadcasts a routing formation packet containing number-of-hops information having a value of zero.

The slave device N5-1 receives the routing formation packet broadcasted by the master device H5-1. Then, the controller 15e of the slave device N5-1 compares the first hop count indicated by the first number-of-hops information contained in this routing formation packet with the second hop count indicated by the second number-of-hops information stored in the storage device 17 of the slave device N5-1. Here, as an example, it is assumed that the first hop count is smaller than the second hop count.

Since the first hop count is smaller than the second hop count, the controller 15e of the slave device N5-1 updates the second number-of-hops information stored in the storage device 17 with the first hop count. Furthermore, the controller 15e of the slave device N5-1 stores the address or identifier of the transmission source of a routing formation packet in the storage device 17 as the transmission destination of a packet that is addressed to the above gateway.

The controller 15e of the slave device N5-1 switches the connection destination from the master device H5-1 to the master device H5-2. The controller 15e of the slave device N5-1 adds one to the first hop count indicated by the first number-of-hops information contained in the routing formation packet. Then, the controller 15e of the slave device N5-1 wirelessly transmits the routing formation packet containing first number-of-hops information having a value of one from the communicator 12 to the master device 5-2.

The master device 5-2 receives the routing formation packet from the slave device N5-1. Then, the controller 24e of the master device 5-2 compares the first hop count indicated by the first number-of-hops information contained in this routing formation packet with the second hop count indicated by the second number-of-hops information stored in the storage device 27 of the master device 5-2. Here, it is assumed that, as an example, the first hop count is smaller than the second hop count.

Since the first hop count is smaller than the second hop count, the controller 24e of the master device 5-2 updates the second number-of-hops information stored in the storage device 27 with the first hop count. Furthermore, the controller 24e of the master device 5-2 stores the address or identifier of the slave device N5-1 being the transmission source of routing formation packet in the storage device 27 of the master device 5-2 as the transmission destination of a packet that is addressed to the master device H5-1. Then, the controller 24e of the master device 5-2 adds one to the first hop count. Then, the controller 24e of the master device 5-2 causes the communicator 22 to broadcast a routing formation packet containing first number-of-hops information having a value of two.

The slave device N5-2 receives the routing formation packet broadcasted by the master device 5-2. Then, the controller 15e of the slave device N5-2 compares the first hop count indicated by the first number-of-hops information contained in this routing formation packet with the second hop count indicated by the second number-of-hops information stored in the storage device 17 of the slave device N5-2. Here, it is assumed that, as an example, the first hop count is smaller than the second hop count.

Since the first hop count is smaller than the second hop count, the controller 15e of the slave device N5-2 updates the second number-of-hops information stored in the storage device 17 with the first hop count. Furthermore, the controller 15e of the slave device N5-2 stores the address or identifier of the transmission source of the routing formation packet in the storage device 17 as the transmission destination of a packet that is addressed to the master device H5-1.

The controller 15e of the slave device N5-2 switches its connection destination from the master device H5-2 to the master device H5-3. The controller 15e of the slave device N5-2 adds one to the first hop count indicated by the first number-of-hops information contained in the routing formation packet. Then, the controller 15e of the slave device N5-2 wirelessly transmits a routing formation packet containing first number-of-hops information having a value of three from the communicator 12 to the master device 5-3.

The master device 5-3 receives the routing formation packet from the slave device N5-2. Then, the controller 24e of the master device 5-3 compares the first hop count indicated by the first number-of-hops information contained in this routing formation packet with the second hop count indicated by the second number-of-hops information stored in the storage device 27 of the master device 5-3. Here, it is assumed that, as an example, the first hop count is smaller than the second hop count.

Since the first hop count is smaller than the second hop count, the controller 24e of the master device 5-3 updates the second number-of-hops information stored in the storage device 27 with the first hop count. Furthermore, the controller 24e of the master device 5-3 stores the address or identifier of the slave device N5-2 being the transmission source of the routing formation packet in the storage device 27 of the master device 5-3 as the transmission destination of a packet that is addressed to the master device H5-1. Then, the controller 24e of the master device 5-3 adds one to the first hop count and causes the communicator 22 to broadcast a routing formation packet containing first number-of-hops information having a value of four.

The slave device C18 receives the routing formation packet subjected to the broadcast transmission by the master device 5-3. In such a manner, a routing from the master device H5-1 to the slave device C18 is formed.

Next, there will be described a process at the time of transporting data from the slave device C18 to the master device H5-1 after the routing from the master device H5-1 to the slave device C18 is established.

The slave device C18 wirelessly transmits data addressed to the master device 5-1 to the master device 5-3.

The master device 5-3 receives data addressed to the master device 5-1 transmitted from the slave device C18. The controller 24e of the master device 5-3 reads out the address or identifier of the slave device N5-2 from the storage device 27, as the transmission destination of a packet that is addressed to the master device H5-1. The transmission destination is thereby specified as the slave device N5-2. Therefore, the controller 24e of the master device 5-3 causes the communicator 22 to transmit the data addressed to the master device 5-1 to the slave device N5-2.

The slave device N5-2 receives the data addressed to the master device 5-1 transmitted by the master device 5-3. Then, the controller 15e of the slave device N5-2 reads out the address or identifier of the master device H5-2 from the storage device 27, as the transmission destination of a packet that is addressed to the master device H5-1. The transmission destination is thereby specified as the master device H5-2. Therefore, the controller 15e of the slave device N5-2 switches the connection destination from the master device H5-3 to the master device H5-2, and wirelessly transmits the data addressed to the master device 5-1 from the communicator 12 to the master device 5-2.

The master device 5-2 receives the data addressed to the master device 5-1 transmitted from the slave device N5-2. The controller 24e of the master device 5-3 reads out the address or identifier of the slave device N5-1 from the storage device 27, as the transmission destination of a packet that is addressed to the master device H5-1. The transmission destination is thereby specified as the slave device N5-1. Therefore, the controller 24e of the master device 5-2 causes the communicator 22 to transmit this data addressed to the master device 5-1 to the slave device N5-1.

The slave device N5-1 receives the data addressed to the master device 5-1 transmitted from the master device 5-2. Then, the controller 15e of the slave device N5-1 reads out the address or identifier of the master device H5-1 from the storage device 27, as the transmission destination of a packet that is addressed to the master device H5-1. The transmission destination is thereby specified as the master device H5-1. Therefore, the controller 15e of the slave device N5-1 switches the connection destination from the master device H5-2 to the master device H5-1, and wirelessly transmits the data addressed to the master device 5-1 from the communicator 12 to the master device 5-1.

The master device 5-1 receives the data addressed to the master device 5-1 transmitted from the slave device N5-1. Once the routing is formed in such a manner, it is possible to transmit data over a plurality of wireless networks.

In addition, the master device 5-1 may transmit this received data to the Internet NW. In such a manner, it is possible to transmit data from the slave device C18 to the Internet NW over a plurality of wireless networks.

As described above, the controller 15e of a first slave device N5 in the fifth embodiment, when the communicator 12 receives, from a first master device H5, a routing formation packet containing first number-of-hops information indicating a hop count from a gateway connected to the Internet up to the first master device H5, compares a first hop count indicated by the first number-of-hops information with a second hop count indicated by the second number-of-hops information stored in the storage device 17. If the result of comparison shows that the first hop count is smaller than the second hop count, the controller 15e of the first slave device N5 updates the second number-of-hops information stored in the storage device 27 with the first hop count. Then, the controller 15e of the first slave device N5 stores the address or identifier of the first slave device N5 being the transmission source of a routing formation packet in the storage device 27, as the transmission destination of a packet that is addressed to the above gateway. The controller 15e of the first slave device N5 switches the connection destination from the first master device to the second master device H5, adds one to the first hop count, and causes the communicator 12 to transmit a routing formation packet containing the first number-of-hops information indicating the first hop count after the addition of one to the second master device H5.

Next, the controller 24e of the second master device H5, when the communicator 22 receives, from the slave device N5 connected to the wireless network formed by the second master device H5, a routing formation packet containing the first number-of-hops information indicating a hop count from a gateway connected to the Internet up to the slave device N5, compares the first hop count indicated by the first number-of-hops information with the second hop count indicated by the second number-of-hops information stored in the storage device 27.

If the result of comparison shows that the first hop count is smaller than the second hop count, the controller 24e of the second master device H5 updates the second number-of-hops information stored in the storage device 27 with the first hop count. Then, the controller 24e of the second master device H5 stores the address or identifier of the first slave device N5 being the transmission source of a routing formation packet in the storage device 27, as the transmission destination of a packet that is addressed to the above gateway. The controller 24e of the second master device H5 adds one to the first hop count, and causes the communicator 22 to broadcast a routing formation packet containing the first number-of-hops information indicating the first hop count after the addition of one.

The address or identifier of the first slave device N5 is thereby stored in the storage device 27 of the second master device H5, as the transmission destination of a packet that is addressed to the gateway, and thus when the second master device H5 receives the packet that is addressed to the gateway from a second slave device N5, the second master device H5 can transfer this packet to the first slave device N5. Then, the first slave device N5 transfers the packet to the first master device H5. It is consequently possible, in an environment where a plurality of wireless networks exist, to transport data across different wireless networks, enabling data to be communicated over a wide area.

Note that, in the present embodiment, the slave device N5 includes the storage device 17, but the present embodiment is not limited thereto, and the storage device 17 may be externally attached to the slave device N5, or may be connected over a network. In addition, in the present embodiment, the master device H5 includes the storage device 27, but the present embodiment is not limited thereto, and the storage device 27 may be externally attached to the master device H5, or may be connected over a network.

Note that the controllers 15, 15b, 15c, and 15d of the slave devices N1 to N4 in the first to fourth embodiments may have the routing function of the controller 15e of the slave device N5 in the fifth embodiment.

In addition, the controllers 24, 24c, and 24d of the master devices H2, H3, and H4 in the second to fourth embodiments may have the routing function of the controller 24e of the master device H5 in the fifth embodiment.

Note that the slave devices N1 to N4 in the first to fourth embodiments have been described to be positioned in a fixed manner, but the first to fourth embodiments are not limited thereto. The slave devices N1 to N4 may move within the overlapped area of the coverage area of the first relay device and the coverage area of the second relay device, or may move outside this overlapped area. For example, the slave devices N1 to N4 does not necessarily exist within this overlapped area when wirelessly communicating with the first relay device, and may be within the coverage area of the first relay device. For example, the slave devices N1 to N4 does not necessarily exist within this overlapped area when wirelessly communicating with the second relay device, and may be within the coverage area of the second relay device.

Note that the description has been made assuming that the slave devices N5-1 to N5-4 in the fifth embodiment is positioned in a fixed manner, but the fifth embodiment is not limited to this, and the slave devices N5-1 to N5-4 may move within the overlapped area of the coverage area of the first relay device and the coverage area of the second relay device.

The communication device and the relay device as described above may also be realized using a general-purpose computer device as basic hardware. That is, each function block (or each section) in the communication device and the relay device can be realized by causing a processor mounted in the above general-purpose computer device to execute a program. In this case, communication device and the relay device may be realized by installing the above described program in the computer device beforehand or may be realized by storing the program in a storage medium such as a CD-ROM or distributing the above described program over a network and installing this program in the computer device as appropriate. Furthermore, the storage may also be realized using a memory device or hard disk incorporated in or externally added to the above described computer device or a storage medium such as CD-R, CD-RW, DVD-RAM, DVD-R as appropriate.

The terms used in each embodiment should be interpreted broadly. For example, the term “processor” may encompass a general purpose processor, a central processor (CPU), a microprocessor, a digital signal processor (DSP), a controller, a microcontroller, a state machine, and so on. According to circumstances, a “processor” may refer to an application specific integrated circuit (ASIC), a field programmable gate array (FPGA), and a programmable logic device (PLD), etc. The term “processor” may refer to a combination of processing devices such as a plurality of microprocessors, a combination of a DSP and a microprocessor, one or more microprocessors in conjunction with a DSP core.

As another example, the term “memory” may encompass any electronic component which can store electronic information. The “memory” may refer to various types of media such as random access memory (RAM), read-only memory (ROM), programmable read-only memory (PROM), erasable programmable read only memory (EPROM), electrically erasable PROM (EEPROM), non-volatile random access memory (NVRAM), flash memory, magnetic or optical data storage, which are readable by a processor. It can be said that the memory electronically communicates with a processor if the processor read and/or write information for the memory. The memory may be integrated to a processor and also in this case, it can be said that the memory electronically communication with the processor.

The term “storage” or “storage device” may generally encompass any device which can memorize data permanently by utilizing magnetic technology, optical technology or non-volatile memory such as an HDD, an optical disc or SSD.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A communication device that wirelessly communicates with a first relay device forming a first wireless network and a second relay device forming a second wireless network, comprising:
a first circuitry to acquire a first signal from the first relay device through wireless communication; and
a second circuitry to create, using the first signal, control information to control a terminal device existing within a coverage area of the second relay device or the second relay device and to cause the first circuitry to wirelessly transmit the control information to the terminal device or the second relay device.

2. The communication device according to claim 1, wherein
the first circuitry further acquires a second signal from the second relay device through wireless communication, and
the second circuitry creates the control information using the first signal and the second signal.

3. The communication device according to claim 2, wherein
the first signal contains first radio resource information on the first relay device, and
the second signal contains second radio resource information on the second relay device.

4. The communication device according to claim 3, wherein
the first radio resource information is a first clock time that is clocked by the first relay device,
the second radio resource information is a second clock time that is clocked by the second relay device,
the first circuitry receives time point information indicating a time point to perform a first process, from a second terminal device existing within a coverage area of the first relay device, and
the second circuitry corrects, using a difference between the first clock time and the second clock time, the time point indicated by the time point information received by the first circuitry, creates a corrected timing being the control information, and causes the first circuitry to transmit the corrected timing to the terminal device existing within the coverage area of the second relay device, the terminal device performing a second process with the corrected timing.

5. The communication device according to claim 3, wherein
the first radio resource information is a first clock time that is clocked by the first relay device,
the second radio resource information is a second clock time that is clocked by the second relay device, and
the second circuitry creates a difference between the first clock time and the second clock time, the difference being the control information, and causes the first circuitry to transmit the difference to the second relay device that changes the second clock time using the difference.

6. The communication device according to claim 3, wherein
the first radio resource information is first traffic information on traffic on the first relay device,
the second radio resource information is second traffic information on traffic on the second relay device, and
the second circuitry judges whether to distribute communication loads between the first relay device and the second relay device, using the first traffic information and the second traffic information, and when it is determined that the communication loads are to be distributed,
the second circuitry creates information to switch a connection destination of a part of the terminal devices connected to the relay device that has a heavier communication load out of the first relay device and the second relay device, to the other relay device, the information created being the control information.

7. The communication device according to claim 6, wherein the second circuitry specifies a terminal device existing within an overlapped area of coverage areas of the first and the second relay devices to be switched, creates an offload request that contains information to identify the specified terminal device, the offload request being the control information, and causes the first circuitry to transmit the offload request to the relay device that has the heavier communication load out of the first relay device and the second relay device.

8. The communication device according to claim 6, wherein the second circuitry specifies a terminal device existing within an overlapped area of coverage areas of the first and the second relay devices to be switched, creates a connection destination switching request of switching the connection destination, the connection destination switching request being the control information, and causes the first circuitry to transmit the connection destination switching request to the specified terminal device.

9. The communication device according to claim 6, wherein
the first traffic information is information on a communication volume in the first relay device or information on a number of terminal devices connected to the first relay device, and
the second traffic information is information on a communication volume in the second relay device or information on a number of communication devices connected to the second relay device.

10. The communication device according to claim 1, wherein the second circuitry creates, using first radio information on a radio wave via which the first signal is received, radio information that contains at least either one of a usage status of a frequency used for wireless communication or a received power of the first signal, the radio information being the control information, and causes the first circuitry to transmit the radio information to the second relay device that determines the frequency to be used for wireless communication based on the radio information.

11. The communication device according to claim 1, wherein
the first signal contains number-of-hops information that indicates a hop count from a gateway connected to an Internet up to the first relay device, and
the second circuitry creates updated-number-of-hops information that indicates an incremented hop count of the hop count indicated by the number-of-hops information by one, the updated-number-of-hops information being the control information, and causes the first circuitry to transmit the updated-number-of-hops information to the second relay device.

12. The communication device according to claim 11, wherein when the first circuitry receives first number-of-hops information, the second circuitry compares a first hop count indicated by the first number-of-hops information with a second hop count indicated by second number-of-hops information stored in a storage device accessible by the communication device, and
when the first hop count is smaller than the second hop count, the second circuitry updates the second number-of-hops information stored in the storage device with the first hop count, and stores an address or identifier of a transmission source of the first number-of-hops information in the storage device, the address or the identifier being a transmission destination of a packet that is addressed to the gateway.

13. The communication device according to claim 1, wherein the first circuitry receives the first signal when the communication device exists within an overlapped area of a coverage area of the first relay device and the coverage area of the second relay device.

14. A relay device that forms a first wireless network, comprising:
a first circuitry to acquire control information from a terminal device, the terminal device creating the control information by using a signal acquired from a different relay device through wireless communication, the different relay device forming a second wireless network different from the first wireless network; and
a second circuitry to perform a process according to the control information.

15. The relay device according to claim 14, wherein
the control information contains a difference between a clock time clocked by the different relay device and a clock time clocked by the relay device,
the relay device further comprising a synchronization timer to count up a synchronization timer value, wherein
the second circuitry updates the synchronization timer value based on the difference.

16. The relay device according to claim 14, wherein
the control information contains radio information that contains at least either one of a usage status of a frequency to be used for wireless communication or a received power of the signal received from the different relay device, and
the second circuitry determines the frequency to be used for the wireless communication by using the radio information.

17. The relay device according to claim 14, wherein
the control information is an offload request that contains terminal identification information to identify a terminal device to be switched to a different connection destination, and
the second circuitry transmits a connection destination switching request of switching the connection destination to a terminal device specified by the terminal identification information contained in the offload request.

18. The relay device according to claim 14, wherein
the control information is number-of-hops information that indicates a hop count from a gateway connected to an Internet up to the terminal device, and
the second circuitry causes the first circuitry to broadcast updated-number-of-hops information that indicates an incremented hop count of the hop count indicated by the number-of-hops information by one.

19. A communication method performed by a communication device that wirelessly communicates with a first relay device forming a first wireless network and a second relay device forming a second wireless network, comprising:
acquiring a first signal from the first relay device through wireless communication;
creating, using the first signal, control information to control a terminal device existing within a coverage area of the second relay device or the second relay device; and
transmitting wirelessly the control information to the terminal device or the second relay device.

20. A communication method performed by a relay device that forms a first wireless network, comprising:
acquiring a control information from a terminal device, the control information being created by the terminal device by using a signal acquired from a different relay device through wireless communication, the different relay device forming a second wireless network different from the first wireless network; and
performing a process according to the control information.
